(19) United States
(12) Patent Application Publication
(10) Pub. No.: US 2017/0185963 A1
(43) Pub. Date: Jun. 29, 2017

(54) INFORMATION PROCESSING APPARATUS, INFORMATION PROCESSING METHOD, AND INFORMATION PROCESSING SYSTEM

(71) Applicants: Hiroshi INABA, Tokyo (JP); Yoshihiro NAGASHIMA, Chiba (JP); Hirotoshi INOO, Tokyo (JP)

(72) Inventors: Hiroshi INABA, Tokyo (JP); Yoshihiro NAGASHIMA, Chiba (JP); Hirotoshi INOO, Tokyo (JP)

(73) Assignee: Ricoh Company, Ltd., Tokyo (JP)

(21) Appl. No.: 15/312,765

(22) PCT Filed: Apr. 20, 2015
(86) PCT No.: PCT/JP2015/062626

§ 371 Date: Nov. 21, 2016

(30) Foreign Application Priority Data
May 30, 2014 (JP) 2014-113163

(51) Int. Cl. G06Q 10/10

(52) U.S. Cl. CPC G06Q 10/109; G06Q 10/105

(57) ABSTRACT

There is provided an information processing apparatus of an information processing system in which a business card reading apparatus, the information processing apparatus, and a terminal device capable of communicating with the information processing apparatus are connected with each other, the information processing apparatus comprising: a storage unit configured to store organizational information of respective organizations each including a section information and a member information; an updating unit configured to update the organizational information, based on the section information and the member information which are extracted from the business card information; a generating unit configured to generate output information for outputting the organizational information where the member information of the member whose business card information has been received can be distinguished from the member information of the member whose business card information has not been received; and an output unit configured to output the output information to the terminal device.

### TECHNICAL FIELD

The present technology relates to an information processing apparatus, an information processing method, and an information processing system.

### BACKGROUND ART

There is a business card management system for optically reading character strings described in a business card by OCR (Optical Character Recognition) to manage the read information. Such a business card management system enables us to associate names of divisions constituting the organization described on the business card with names of people belonging to the division, thereby managing the information.

Japanese Laid-open Patent Publication No. 2003-296353 discloses a business card OCR system for reading the business card with an OCR process to store the read information in a database, and is capable of correcting, editing or deleting the information based on a request.

Japanese Laid-open Patent Publication No. 2012-049906 discloses a system which reads a plurality of the business cards at a time of creating a read image, and obtains images and information on a business card basis from the read image, thereby generating or updating business card management data for managing the business card on a page basis.

The information registered in the business card management system is expected to be used in sales activity in order to comprehend an organizational structure of a company. However, the conventional business card management system can manage only information of people whose business cards have been actually obtained. Therefore, it is difficult to visualize the information of a person, whose business card has not been obtained, important for the sales activity or the structure of the organization to which the person belongs.

### RELATED ART DOCUMENT

### Patent Document

[Patent Document 1]: Japanese Laid-open Patent Publication No. 2003-296353

[Patent Document 2]: Japanese Laid-open Patent Publication No. 2012-049906

### DISCLOSURE OF THE INVENTION

### Problems to be Solved by the Invention

An object of disclosure of the present technology is to encourage the performance of an effective sales activity by using business card information.

### Means for Solving the Problems

According to an embodiment of the present invention, there is provided an information processing apparatus of an information processing system in which a business card reading apparatus for reading business card information, the information processing apparatus for processing the business card information, and a terminal device capable of communicating with the information processing apparatus are connected with each other through a network, the information processing apparatus comprising: a storage unit configured to store organizational information of respective organizations each including section information for indicating a section included in an organization and member information related to a member of the section; an updating unit configured to update the organizational information, based on the section information and the member information of the section which are extracted from the business card information, so that the member information of the member whose business card information has been received can be distinguished from the member information of the member whose information of the business card has not been received, in the organizational information; a generating unit configured to generate output information for outputting the organizational information where the member information of the member whose business card information has been received can be distinguished from the member information of the member whose business card information has not been received; and an output unit configured to output the output information generated by the generating unit to the terminal device.

### Effects of the Present Invention

According to the disclosed technology, effective sales activity by using business card information can be achieved.

### BRIEF DESCRIPTION OF THE DRAWINGS

FIG. 1 is a schematic diagram for illustrating a system according to one embodiment;

FIG. 2 is a block diagram for illustrating a hardware configuration of an information processing apparatus or an information terminal according to one embodiment;

FIG. 3 is a block diagram for illustrating the system 1 according to one embodiment;

FIG. 4 is a diagram for showing an example of the organizational information management table for storing the organizational information;

FIG. 5 is a diagram for showing an example of a position management table for storing the position information;

FIG. 6 is a diagram for showing an example of the initial state company information table for storing the company information;

FIG. 7 is a diagram for showing an example of the company information table for storing the company information;

FIG. 8 is a diagram for showing an example of an output setting information management table for storing the output setting information;

FIG. 9 is a diagram for showing an example of a user setting information management table for storing the user setting information;

FIG. 10 is a drawing for illustrating an example of a business card reading screen displayed by a business card reading apparatus;

FIG. 11 is a drawing for showing an example of an output image generated by the generating unit;

FIG. 12 is a drawing for showing another example of the output image generated by the generating unit;

FIG. 13 is a flowchart for illustrating an example of an initial process performed by the information processing apparatus according to one embodiment;

FIG. 14 is a flowchart for illustrating an example of an updating process performed by the information processing apparatus according to one embodiment;

FIG. 15 is a flowchart illustrating an output process performed by the information processing apparatus according to one embodiment;

FIG. 16 is a sequence diagram for illustrating an example of an operation of the system 1 according to one embodiment; and

FIG. 17 is another schematic diagram for illustrating a system according to one embodiment.

### MODE FOR CARRYING OUT THE INVENTION

Herein below, embodiments will be described with reference to the accompanying drawings.

1. System

2. Hardware Configuration

3. Function

4. Example Operation
Initial Process
Update Process
Output Process
Example Operation of System

5. Effect

<1. System>

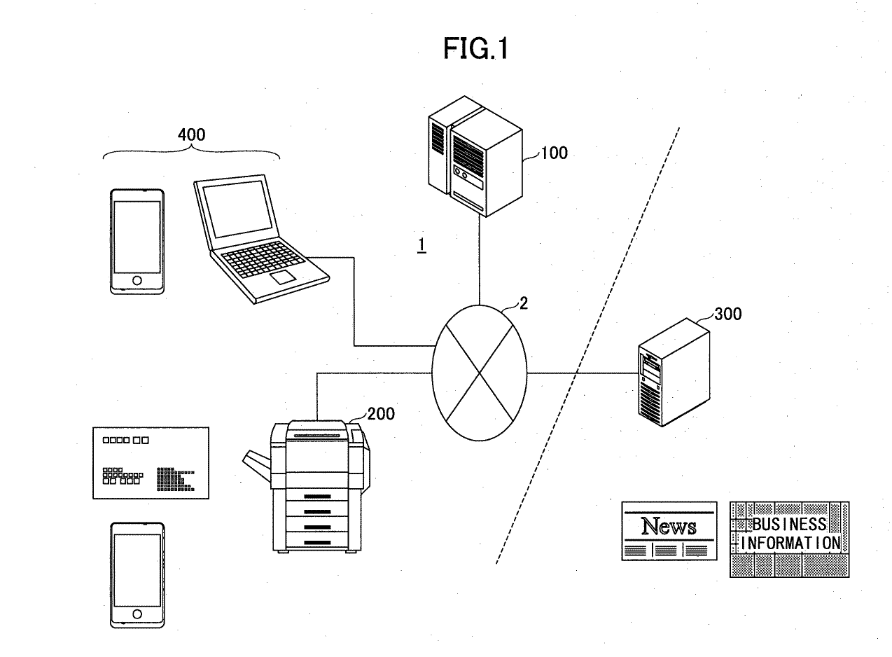

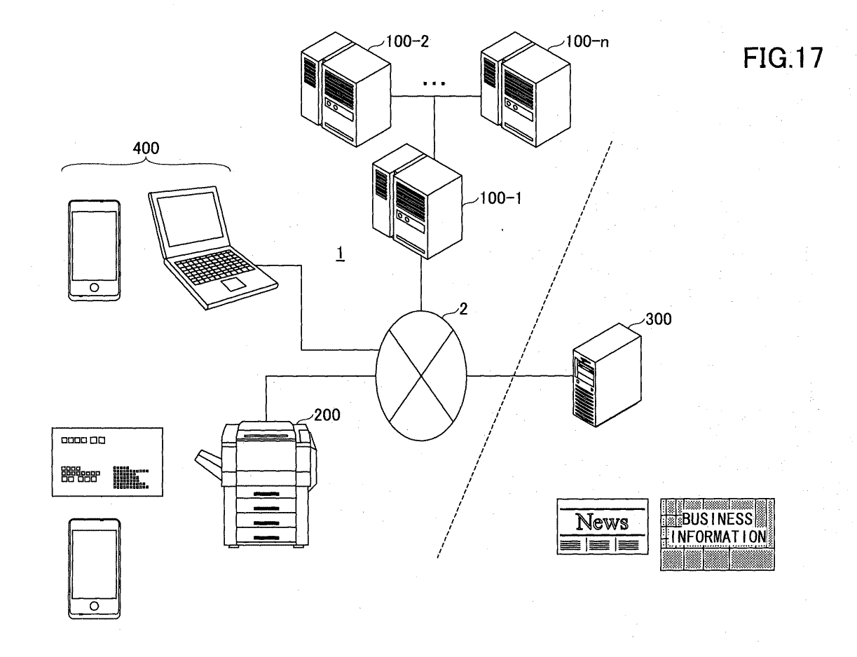

FIG. 1 is a schematic diagram for illustrating a system 1 of the present embodiment. The system 1 includes an information processing apparatus 100 for managing business card information, a business card reading apparatus 200 for reading business cards, an information providing apparatus 300 for providing investor relations or personnel information being stored in electronic media, and an information terminal 400 of a salesperson performing sales activity. The information processing apparatus 100, the business card reading apparatus 200, the information providing apparatus 300 and the information terminal 400 communicate with each other through a network 2. Additionally, as shown in FIG. 17, the information processing apparatus 100 may be configured by more than one information processing apparatus 100-1 to 100-n.

The information processing apparatus 100 manages the business card information by defining, in advance, low-order organizations included in an organization to be managed. For example, in a case where the organization to be managed is a company, the information processing apparatus 100 defines, in advance, five certain low-order organizations (departments) of the corporate planning department, the general affairs department, the corporate sales department, the information system department, and the material procurement department, which are important for sales activity.

Further, the information processing apparatus 100 defines, in advance, general roles of the respective low-order organizations to manage the business card information. For example, in a case where the organization to be managed is a company, the information processing apparatus 100 defines, in advance, five roles (positions) included as in the executive, the business unit president, the director, the manager and the staff. Then, the information processing apparatus 100 can manage acquisition of the business card in every low-order organization on a position basis. In the following, an example in a case where a company is the organization to be managed in the information processing apparatus 100 will be described.

Information of the organization, the department, and the name of the person described on the business card is read by the business card reading apparatus 200 when the salesperson receives the business card. The business card reading apparatus 200 sends the read information to the information processing apparatus 100 through the network 2. The information processing apparatus 100, receiving the information of the organization, the department and the name of the person, stores the received information associated with any one of the predetermined departments and positions.

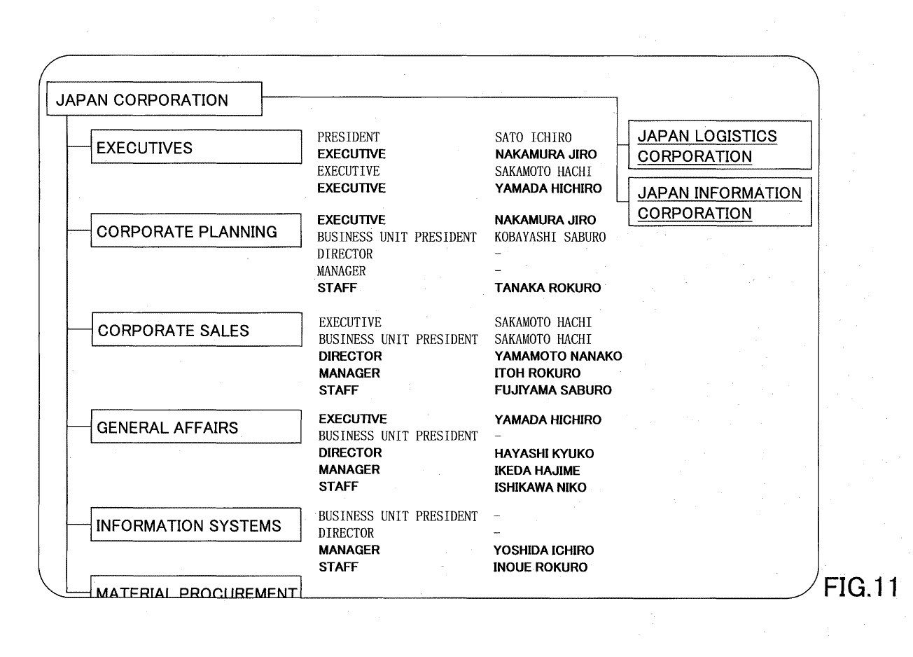

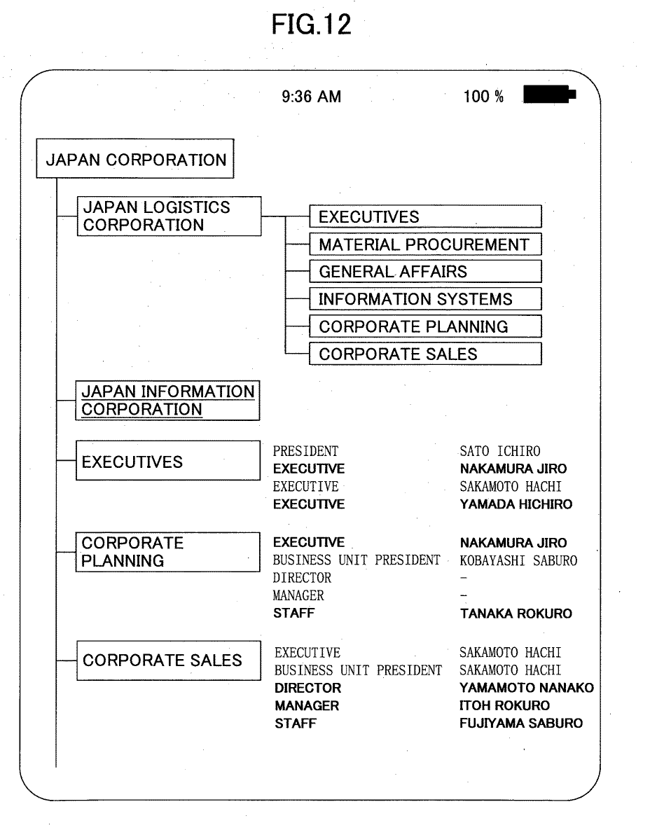

The information processing apparatus 100 manages the information by distinguishing a position whose business card information has been received from a position whose business card information has not been received. The information processing apparatus 100 visually outputs information of all departments and positions in an organization indicating whether the business card information has been received or not in response to a request from the information terminal 400 used by the salesperson planning to perform the sales activity. Although a detailed description will be given below, FIG. 11 and FIG. 12 show examples of screen images displayed by the information processing apparatus 100. Here, presence of the business card information is indicated by color gradation of characters of the positions and the names.

Additionally, the information processing apparatus 100 can receive, from the information providing apparatus 300 through the network 2, the name of the person who holds the position whose business card information has not been received. For example, the information providing apparatus 300 is a web server for providing the personnel information or the investor relations, and the information processing apparatus 100 can identify, in advance, all or part of the names of the people holding the positions included in a department in a company by using the information received from the information providing apparatus 300.

As described above, the system 1 of the present embodiment manages information indicating whether the business card has been received or not, on a predetermined role of the low-order organization basis. Then, the system 1 can output the information indicating whether the business card has been received or not to the information terminal 400 used by the salesperson. Thus, the salesperson will have a hint to perform the sales activity mainly on the people whose business cards have not been received, thereby planning an effective sales strategy.

<2. Hardware Configuration>

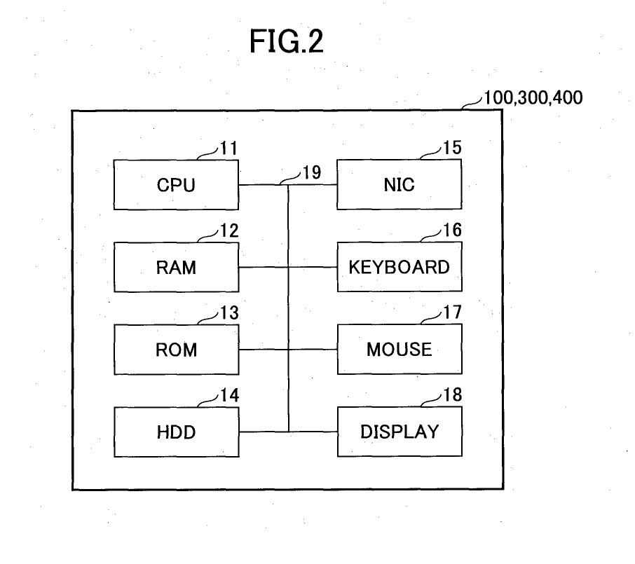

FIG. 2 is a block diagram for illustrating a hardware configuration of the information processing apparatus 100, the information providing apparatus 300 and the information terminal 400 of the present embodiment. The information processing apparatus 100 and the information providing apparatus 300 and the information terminal 400 respectively include a CPU 11, a RAM 12, a ROM 13, a HDD 14, a NIC (Network Interface Card) 15, a keyboard 16, a mouse 17 and a display 18.

The CPU 11 executes a program for controlling the operation of the information processing apparatus 100, the information providing apparatus 300 or the information terminal 400. The program controls the operation of the information processing apparatus 100, the information providing apparatus 300 or the information terminal 400 so as to perform all of or a part of functions described below. The RAM 12 is configured to provide a working area for the CPU 11. The ROM 13 stores a system program for activating the information processing apparatus 100, the information providing apparatus 300, or the information terminal 400. The HDD 14 stores the OS (Operating System) for managing the operation of the information processing apparatus 100, the information providing apparatus 300 or the information terminal 400, or data necessary for the OS's operation. Also, the HDD 14 stores application programs or user data. Additionally, a flash memory may be used instead of the HDD 14 in the information terminal 400.

The NIC 15 is disposed for connecting to a LAN. Additionally, a wireless communication device may be disposed instead of the NIC 15 in the information terminal 400. The keyboard 16 and the mouse 17 are devices for accepting input from system administrators or the like of the information processing apparatus 100 and the information providing apparatus 300. Additionally, the information terminal 400 may include a touch sensor device instead of the keyboard 16 and the mouse 17. The display 18 is a device for displaying information for the user of the information processing apparatus 100, the information providing apparatus 300 or the information terminal 400. The bus 19 electrically connects above described devices.

Additionally, the information processing apparatus 100 or the information providing apparatus 300 may serve as a server computer and may input/output information from/to other client computers connected through the network. In this case, the information processing apparatus 100 or the information providing apparatus 300 may not include the keyboard 16, the mouse 17 and the display 18.

Also, the information processing apparatus 100 or the information providing apparatus 300 may be configured by a single housing or multiple housings. For example, the information processing apparatus 100 or the information providing apparatus 300 may use network storages for storing the data instead of the HDD 14.

<3. Function>

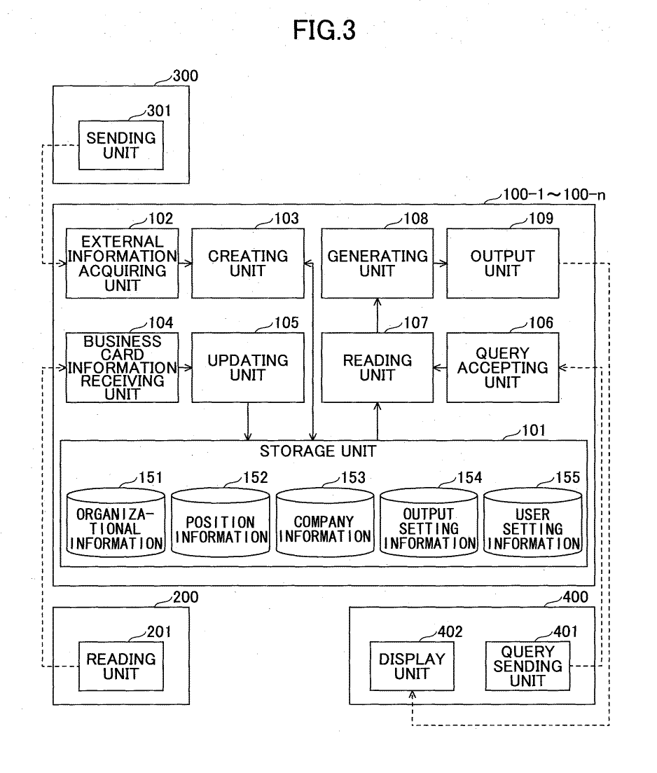

FIG. 3 is a block diagram for illustrating the system 1 of the present embodiment. The information processing apparatus 100 in the system 1 includes a storage unit 101, an external information acquiring unit 102, a creating unit 103, a business card information receiving unit 104, an updating unit 105, a query accepting unit 106, a reading unit 107, a generating unit 108, and an output unit 109. The storage unit 101, configured by the HDD 14 shown in FIG. 2, stores organizational information 151, position information 152, company information 153, output setting information 154 and user setting information 155.

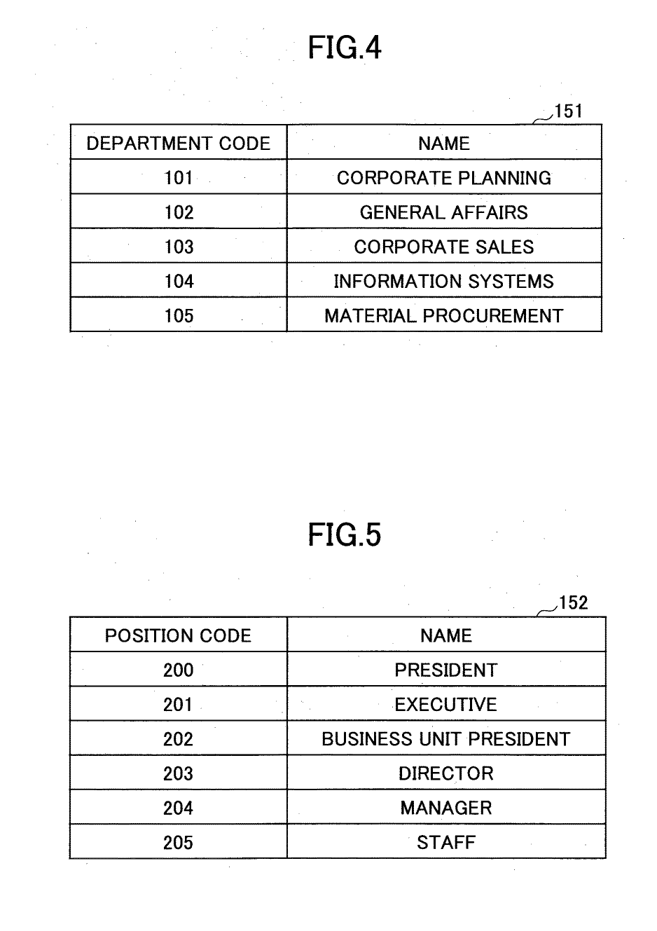

In the organizational information 151, department codes of the departments which constitute the company are recoded where the department codes are associated with the name of the departments. FIG. 4 is a diagram for showing an example of the organizational information management table for storing the organizational information 151. As shown in FIG. 4, the organizational information management table includes items of “Department Code” and “Name”. The “Department Code” is an identifier for identifying the department. The “Name” indicates the name of the department. In the example shown in FIG. 4, five departments belonging to the company, which are “Corporate Planning”, “General Affairs”, “Corporate Sales”, “Information Systems” and “Material Procurement”, are defined.

In the position information 152, position codes indicative of positions of members constituting the low-order organization defined in the organizational information 151 are recorded where the position codes are associated with the names of the positions. FIG. 5 is a diagram for showing an example of a position management table for storing the position information 152. As shown in FIG. 5, the position information management table includes items of “Position Code” and “Name”. The “Position Code” is an identifier for identifying the position. The “Name” indicates the name of the position. In FIG. 5, the positions, included in every department (except “President”), are defined.

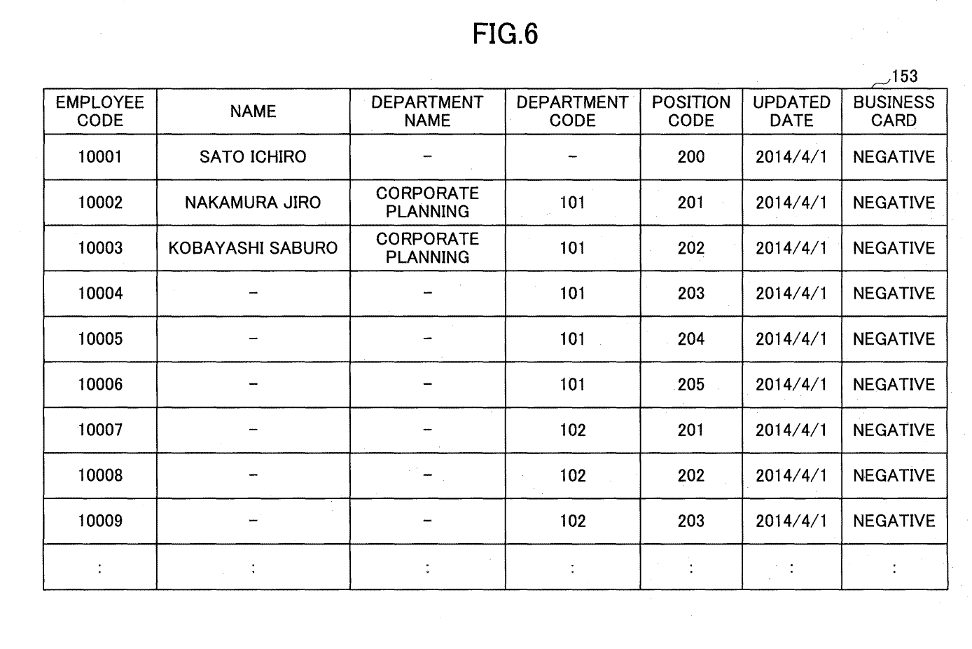

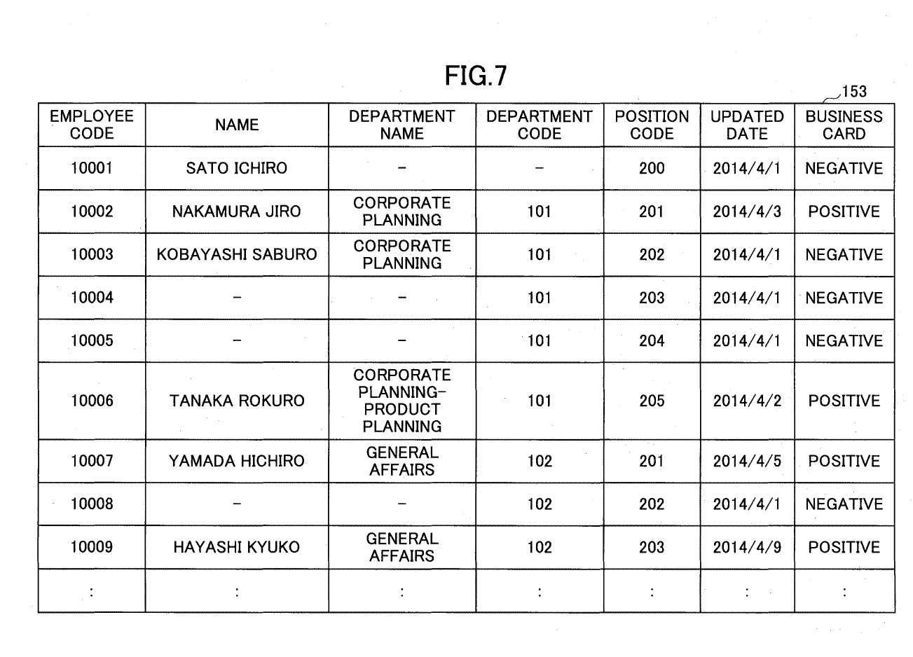

The company information 153 is created on a company basis, and includes information of employees. FIG. 6 is a diagram for showing an example of the company information 153. FIG. 7 is a diagram for showing another example of the company information 153. As shown in FIG. 6 and FIG. 7, the company information management table includes items of “Employee Code”, “Name”, “Department Name”, “Department Code”, “Position Code”, “Updated Date”, and “Business Card”.

The “Employee Code” is an identifier for identifying an employee. The “Name” indicates a name of the employee. The “Department Name” indicates the actual name of a department, described on the business card, to which the employee belongs. The “Department Code” indicates a code of a department, among the departments defined in the organizational information 151 shown in FIG. 4, corresponding to the actual name of a department to which the employee belongs. The “Position Code” indicates a code of a position, among the positions defined in the position information 152 shown in FIG. 5, corresponding to the position which is held by the employee. The “Updated Date” indicates a date of last update of the entry. “Business Card” indicates whether a business card of the employee has been received or not. (“Positive” indicates that the business card has been received, while “Negative” indicates that the business card has not been received.)

Additionally, FIG. 6 shows an example of company information 153 of a company just after creation, while FIG. 7 shows an example of the company information 153 updated based on the read business card information acquired by the salesperson.

The output setting information 154 is setting information used for outputting information of respective companies. FIG. 8 shows an example of an output setting information management table for storing the output setting information 154. As shown in FIG. 8, the output setting information management table includes items of “Company Code”, “Company Name”, “Display Sequence”, and “Subsidiary Company Code”.

The “Company Code” is an identifier for identifying a company. The “Company Name” indicates a name of the company. The “Display Sequence” indicates a sequence in which departments are output, described by using the “Department Code”, in a case where information of a department in a company is output. For example, when “101,102,103,104,105” is described as a value of the item “Display Sequence”, the departments are output in a sequence of the “Corporate Planning”, the “General Affairs”, the “Corporate Sales”, the “Information Systems”, and the “Material Procurement”. The “Subsidiary Company Code” indicates the company code of a subsidiary company (affiliate company) in a case where the company has a subsidiary company.

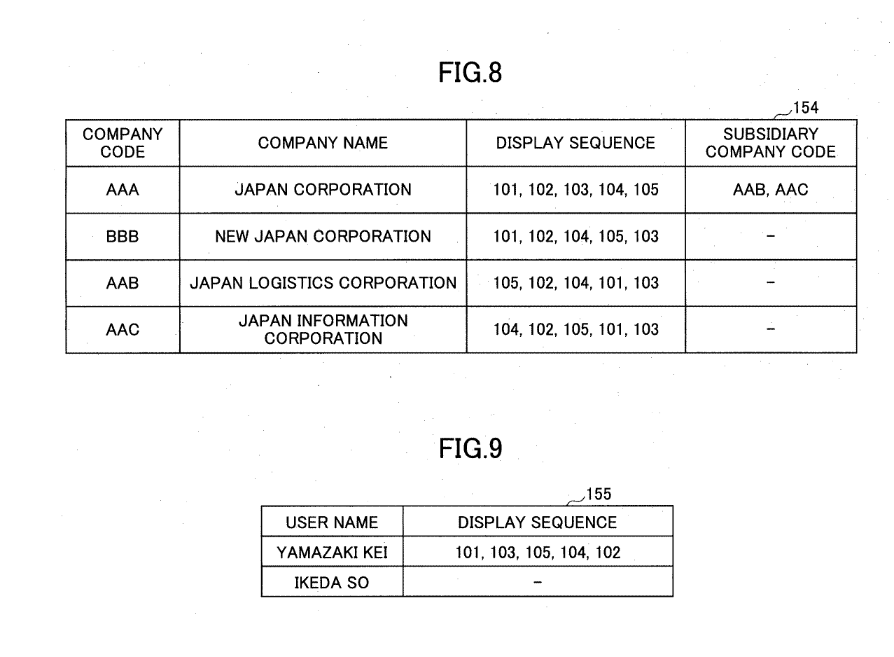

The user setting information 155 defines an output setting of the information of the department for every user (salesperson) of the information processing apparatus 100. FIG. 9 is a diagram for showing an example of a user setting information management table for storing the user setting information 155. As shown in FIG. 9, the user setting information management table includes items of “User Name” and “Display Sequence”.

The “User Name” indicates a user name for identifying a user performing a login to the information processing apparatus 100. The “Display Sequence” indicates an sequence in which the departments are output in a case where the information of the department is output by the user. The “Display Sequence” set in the user setting information 155 may be prioritized over the “Display Sequence” set in the output setting information 154 shown in FIG. 8. The user setting information can be changed by the user if needed.

With reference to FIG. 3, the external information acquiring unit 102 is achieved mainly by the process performed by the CPU 11 or NIC 15 shown in FIG. 2, and acquires external information, such as the personnel information or investor relations, sent from a sending unit 301 of the information providing apparatus 300. The external information includes the company name, the name of department, the name of position and the name of employee. For example, the external information is described in XML (Extensible Markup Language) and received through the network.

Also, the external information acquiring unit 102 may acquire external information obtained by the reading unit 201 of the business card reading apparatus 200 by scanning papers (for example, newspapers, brochures, or documents distributed). The external information acquiring unit 102 may acquire external information which is digitalized through the OCR process.

The creating unit 103 is achieved mainly by the process performed by the CPU 11 shown in FIG. 2, and constitutes the company information management table for storing the company information 153 of a company, by using the organizational information 151 and the position information 152 having been created in the storage unit 101 in advance. Also, the creating unit 103 receives the external information from the external information acquiring unit 102 to update the company information management table. Thus, for example, the company information management table shown in FIG. 6 is constituted.

Specifically, the creating unit 103 reads the organizational information management table shown in FIG. 4 and the position information management table shown in FIG. 5. Then, the creating unit 103 creates the company information management table including entry of the “President” which does not belong to any department, and entries of five positions of the “Executive”, the “Business Unit President”, the “Director”, the “Manager” and the “Staff” respectively belonging to five respective departments.

The creating unit 103 assigns the “Employee Code” to the respective created entries, where values of the items of the “Name” and the “Department Name” remain null, while the value of the items of the “Department Code” and the “Position Code” are set as those shown in FIG. 4 and FIG. 5. Also, the creating unit 103 sets the date when the company information management table is created in the item of the “Updated Date”, while setting “Negative” in the item of “Business Card”. Here, the creating unit 103 can create twenty six entries in total.

Then, the creating unit 103, in a case where the external information is available, identifies the company information management table by using the company name included in the external information received from the external information acquiring unit 102. Next, the creating unit 103 stores the department name, the position name, and the employee name, included in the external information, in the constituted company information management table. The department name of a person included in the external information and the corresponding department code may be automatically associated with each other by a database for associating the department names with the department codes, or may be manually associated with each other by the salesperson.

Here, the respective department names and positions of the employees of “Sato Ichiro”, “Nakamura Jiro”, “Kobayashi Saburo”, “Kato Shiro”, Sakamoto Hachi” and “Hayashi Kyuko” included in the external information are acquired, and thereby updating the company information management table shown in FIG. 6. Additionally, “Sato Ichiro” is the “President”, representing the company, whose department name remains null.

The business card information receiving unit 104 is achieved by the process of the CPU 11 and the NIC 15 shown in FIG. 2, and receives business card information sent from the reading unit 201 of the business card reading apparatus 200.

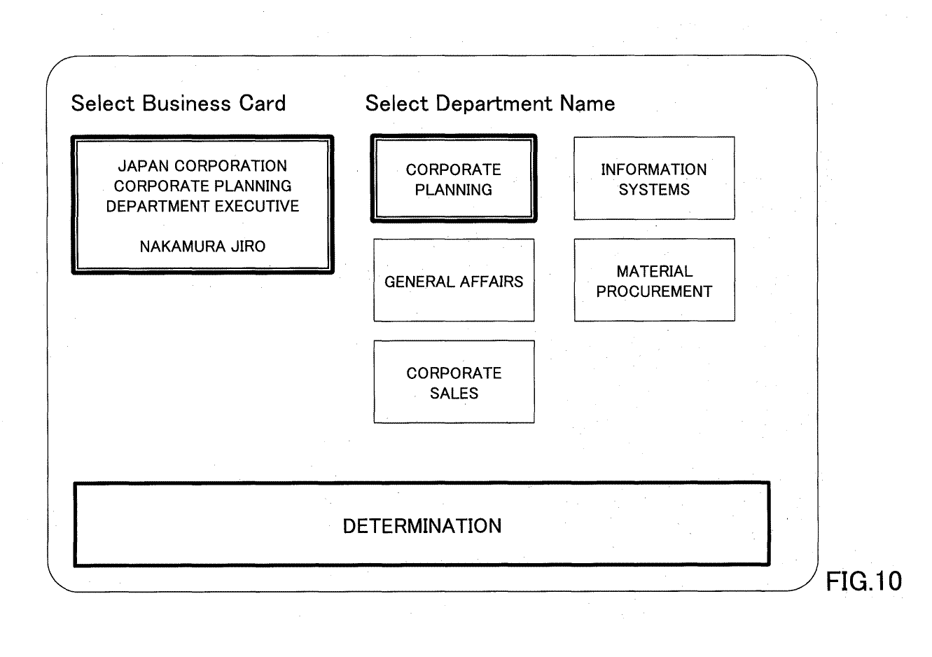

Here, the business card information sent from the reading unit 201 of the business card reading apparatus 200 is described. The reading unit 201 of the business card reading apparatus 200 scans the business card designated by the salesperson to read information of the business card through an operation screen shown in FIG. 10. The salesperson selects the business card to be scanned and further selects the department name of a person of the business card from five options prepared in advance.

The five options of the department name shown in FIG. 10 correspond to five departments shown in FIG. 4. The reading unit 201 of the business card reading apparatus 200 sends “Company Name”, “Department Name”, “Position Name”, and “Name” described in the selected business card and the selected department name (collectively referred to as “business card information”) to the business card information receiving unit 104 of the information processing apparatus 100. In the example shown in FIG. 10, when selecting and pushing a determination button by the salesperson, the following information is sent to the information processing apparatus 100.

“Company Name”; “Japan Corporation”

“Name”; “Nakamura Jiro”

“Department Name”; “Corporate Planning”

“Position”; “Executive”

“Selected Department Name”; “Corporate Planning”

The business card information receiving unit 104 receives the above mentioned business card information through the network 2, from time to time, thereby providing the business card information to the updating unit 105.

The updating unit 105 is achieved by the process of the CPU 11 shown in FIG. 2, and updates the company information 153 stored in the storage unit 101 by using the business card information provided by the business card information receiving unit 104.

Specifically, the updating unit 105 identifies, for example, the company information management table of a company shown in FIG. 6 by using the “Company Name” included in the business card information. Then, the updating unit 105 converts the “Selected Department Name” and the “Position” included in the business card information into the “Department Code” and the “Position Code” by using the organizational information 151 shown in FIG. 4 and the position information 152 shown in FIG. 5. The updating unit 105 sets the “Name” and the “Department Name” included in the business card information in the entry identified by the “Department Code” and the “Position Code”.

Also, the updating unit 105 sets the date when the business card information is received in the item “Updated Date”, and sets the “Positive” in the item “Business Card”. FIG. 7 shows the updated company information management table. In the example of FIG. 7, business cards of “Tanaka Rokuro”, “Yamada Hichiro”, and “Hayashi Kyuko” have been received other than that of “Nakamura Jiro” described in FIG. 10.

Additionally, the updating unit 105 may create a new entry having a new employee code in a case where the business card information, whose “Department Code” and the “Position Code” are the same as a previous one while the “Name” is different from it, is received. For example, it is expected that a plurality of managers and staff belong to the same department.

The updating unit 105 may update the company information management table in response to every receipt of business card information from the business card information receiving unit 104, or may collectively update after receiving a certain amount of business card information from the business card information receiving unit 104.

The query accepting unit 106 is achieved by the process of the CPU 11 shown in FIG. 2, and accepts a query sent from the query sending unit 401 of the information terminal 400. Here, the query sent from the query sending unit 401 of the information terminal 400 includes the user name of the salesperson operating the information terminal 400 and the company name of a company whose information is to be displayed. The query accepting unit 106 informs the reading unit 107 of acceptance of the query, as well as the user name and the company name included in the query.

Additionally, the query sending unit 401 of the information terminal 400 is achieved by the process of the CPU 11 shown in FIG. 2, and accepts operational input by the salesperson on a screen of a web browser or application program, thereby requesting the information processing apparatus 100 to output the company information of a company. The sales person is identified by inputting the user name and the company name by himself/herself, or identified by selecting them from a list prepared in advance.

The reading unit 107 is achieved by the process of the CPU 11, and retrieves the company information table, which corresponds to the company name obtained from the query accepting unit 106, from the storage unit 101. Also the reading unit 107, with reference to the output setting information 154 stored in the storage unit 101, reads the “Display Sequence” and “Subsidiary Company Code” corresponding to the company name obtained from the query accepting unit 106.

Here, in a case where the “Subsidiary Company Code” is included, the “Company Code”, the “Company Name” and the “Display Sequence” of the company (subsidiary company) corresponding to the “Subsidiary Company Code” are further read with reference to the output setting information 154. Then, the reading unit 107 retrieves the company information management table of the subsidiary company (not shown) in accordance with the “Company Name” of the subsidiary company, from the storage unit 101.

Further, the reading unit 107 reads the “Display Sequence” corresponding to the user name obtained from the query accepting unit 106 with reference to the user setting information stored in the storage unit 101. The reading unit 107 provides the generating unit 108 with such read information.

The generating unit 108 is achieved by the process of the CPU 11 shown in FIG. 2, and generates an output image of the company information to be output by using information received from the reading unit 107. FIG. 11 is a drawing for showing an example of an output image generated by the generating unit 108. FIG. 12 is a drawing for showing another example of the output image generated by the generating unit 108. The generating unit 108 generates the output image in which the names of the people at respective positions in the respective departments are shown so as to be able to determine whether the business card has been received or not. The generating unit 108 provides the output unit 109 with the generated output image.

In the examples shown in FIG. 11 and FIG. 12, whether the business card has been received or not is indicated by gradation of characters of the positions and the names of the employees. The generating unit 108 can indicate whether the business card has been received or not by the color or size of the characters, labels, icons or the like, other than the case of FIG. 11 and FIG. 12.

Specifically, the generating unit 108 generates an output image for hierarchically showing names of people at the respective positions in the five respective departments based on information stored in the company information management table received from the reading unit 107. Here, the generating unit 108 creates the item “Executives” in the same hierarchy as that of the five departments, thereby cross-divisionally listing the names of the executives belonging to the respective departments.

Also, the generating unit 108 may output the names of the subsidiary companies received from the reading unit 107 with the “Executives” and the five departments. In the example shown in FIG. 11, the company names of the subsidiary companies are shown separately from the “Executives” and the five departments. Also, in the example of FIG. 11, only the company names of the subsidiary companies are shown while information indicating the departments and employees which constitute the subsidiary company is not shown. The company names of the subsidiary companies may be hyper-linked, and the company information of the subsidiary company may be displayed when selecting the company name of the subsidiary company.

In the example shown in FIG. 12, the company names of the subsidiary companies are shown in the same hierarchy as that of the “Executives” and the five departments. In the example of FIG. 12, the output image is output so that the information indicating the departments and employees which constitute the subsidiary company can be shown in the same screen. In the example of FIG. 12, the departments of “Japan Logistics Corporation”, which are selected explicitly by the user, are shown in a tree state while the departments of “Japan Information Corporation” which are not selected by the user, are not shown. Also, in the example of FIG. 12, although information indicating the employees belonging to the respective departments of the “Japan Logistics Corporation” is not shown, information indicating the employees may be shown in response to a user's selection of the department name.

Also, the generating unit 108 outputs the information indicating the five departments based on the display sequence received from the reading unit 107. Further, in a case where the display sequence included in the user setting information is read, the generating unit 108 changes the display sequence of the five departments so as to prioritize the read display sequence. For example, in a case where information of the “Japan Corporation” is output according to an operation of a user “Yamazaki Kei” shown in FIG. 9, the generating unit 108 does not refer to the display sequence read from the output setting information 154. Instead, the generating unit 108 refers to the display sequence of “101,103,105,104,102” read from the user setting information 155, thereby outputting the information where the departments are shown in sequence of the “Corporate Planning”, the “Corporate Sales”, the “Material Procurement”, the “Information Systems”, and the “General Affairs” (FIG. 11).

The generating unit 108 may generate the output image by using any existing format. For example, the generating unit 108 may generate the output image by using Javascript, Flash, HTML5, an UI toolkit for PCs or smartphones, image data with a link, or the like.

The output unit 109 is achieved by the process of the CPU 11 and the NIC 15, and outputs the output image generated by the generating unit 108 to a display unit 402 of the information terminal 400. Additionally, the display unit 402 of the information terminal 400 is achieved by the process of the CPU 11 and the display 18 shown in FIG. 2, and displays the output image from the output unit 109 on the display 108.

<4. Example Operation>

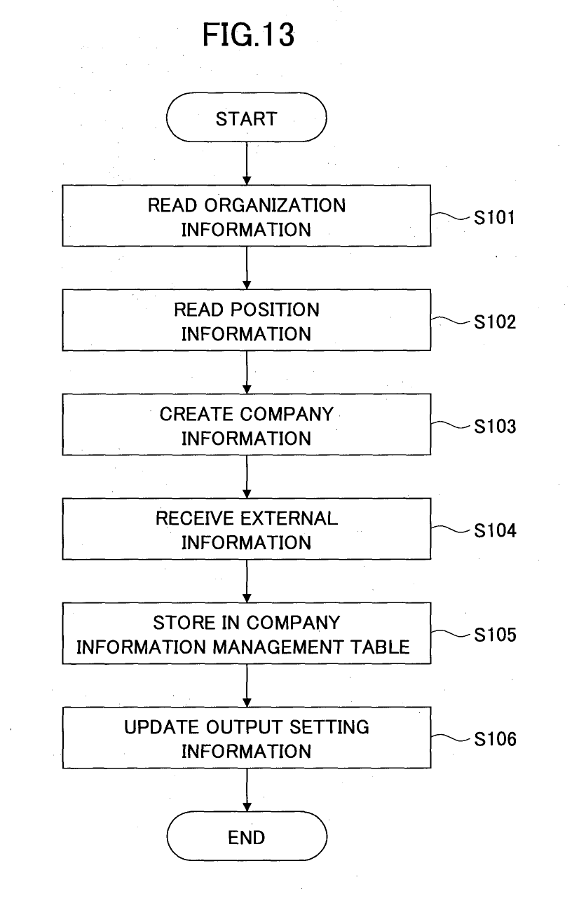

In the following, a process performed by the information processing apparatus 100 of the present embodiment and an example operation of the system 1 of the present embodiment will be described with reference to FIG. 13-FIG. 16.

FIG. 13 is a flowchart for illustrating an example of an initial process performed by the information processing apparatus 100 of the present embodiment.

First, the creating unit 103 reads the organizational information 151 shown in FIG. 4 (step S101). Then, the creating unit 103 reads the position information 152 shown in FIG. 5 (step S102). The creating unit 103 creates the company information 153 which includes an entry of the “President” belonging to none of the departments and entries of five positions of the “Executive”, the “Business Unit President”, the “Director”, the “Manager” and the “Staff” respectively belonging to five respective departments (step S103).

Here, the creating unit 103 assigns the “Employee Code” to the respective created entries, where values of the items of the “Name” and the “Department Name” remain null, while the value of the items of the “Department Code” and the “Position Code” are set as those shown in FIG. 4 and FIG. 5. Also, the creating unit 103 sets the date when the company information management table is created in the item of the “Updated Date”, while setting “Negative” in the item of “Business Card”.

The creating unit 103 receives the external information including the company name, the name of department, the name of position and the name of employee from the information providing apparatus 300 through the external information acquiring unit 102 (step S104). The creating unit 103 stores the name of department, the name of position and the name of employee, which are included in the external information, in the company information management table (step S105). Additionally, as described above, the department name of a person included in the external information and the corresponding department code may be automatically associated with each other by a database for associating the department names with the department codes, or may be manually associated with each other by the salesperson.

Then, the creating unit 103 creates an entry of a company corresponding to the entries created in step S103, thereby updating the output setting information 154 shown in FIG. 8 (step S106). An example of the company information management table constituted through the above described process is shown in FIG. 6. Also, an example of the output setting information management table updated through the above described process is shown in FIG. 8.

<Updating Process>

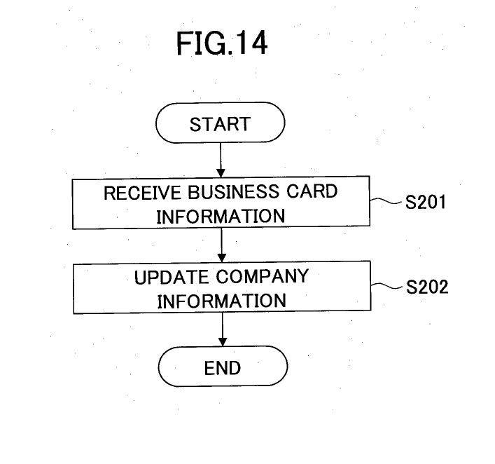

FIG. 14 is a flowchart for illustrating an example of an updating process performed by the information processing apparatus 100 of the present embodiment.

The updating unit 105 receives the business card information including the “Company Name”, “Department Name”, “Position Name”, the “Name” and the “Selected Department Name” from the business card reading apparatus 200 through the business card information receiving unit 104 (step S201). Then, the updating unit 105 updates the company information 153 stored in the storage unit 101 based on the received business card information (step S202).

Specifically, the updating unit 105 identifies, for example, the company information management table of a company shown in FIG. 6 by using the “Company Name” included in the business card information. Then, the updating unit 105 converts the “Selected Department Name” and the “Position” included in the business card information into the “Department Code” and the “Position Code” by using the organizational information 151 shown in FIG. 4 and the position information 152 shown in FIG. 5. The updating unit 105 sets the “Name” and the “Department Name” included in the business card information in the entry identified by the “Department Code” and the “Position Code”. Also, the updating unit 105 sets the date when the business card information is received in the item “Updated Date”, and sets “Positive” in the item “Business Card”.

An example of the company information management table updated through the above described process is shown in FIG. 7.

<Output Process>

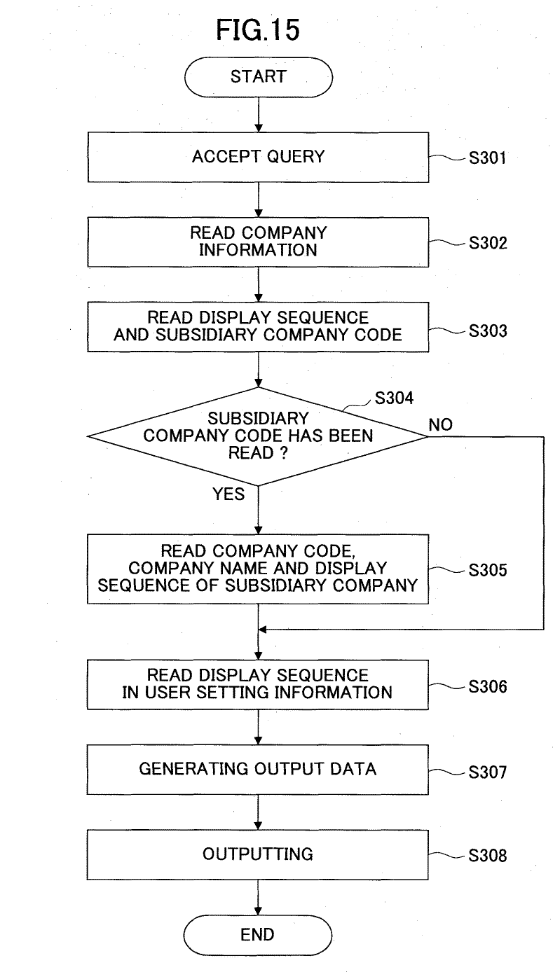

FIG. 15 is a flowchart illustrating an outputting process performed by the information processing apparatus 100 of the present embodiment.

First, the query accepting unit 106 accepts a query, including the user name of the salesperson and the company name of the company whose information is to be displayed, sent from the query sending unit 401 of the information terminal 400 (step S301). Then, the reading unit 107 reads the company information corresponding to the company name in the accepted query from the storage unit 101 (step S302). The reading unit 107, with reference to the output setting information 154, reads the “Display Sequence” and the “Subsidiary Company Code” corresponding to the company name in the accepted query (step S303).

Here, the reading unit 107 determines whether one “Subsidiary Company Code” or more are read (step S304). When one “Subsidiary Company Code” or more are read (YES to step S304), the reading unit 107 further reads the “Company Code”, the “Company Name” and the “Display Sequence” of the company (subsidiary company) corresponding to the “Subsidiary Company Code” with reference to the output setting information 154 shown in FIG. 8 (step S305).

When a “Subsidiary Company Code” is not read (NO to step S304), or after performing the process of step S305, the reading unit 107 reads the “Display Sequence” corresponding to the user name informed by the query accepting unit 106 with reference to the user setting information stored in the storage unit 101 (step S306).

Then, the generating unit 108 generates the output image of the company information to be output by using the information read by the reading unit 107 (step S307). Examples of the output image generated by the generating unit 108 are shown in FIG. 11 and FIG. 12. The generating unit 108 generates the output image in which the names of the people at respective positions in the respective departments are shown so as to be able to comprehend whether the business card has been received or not. As described above, the output image is generated. Then, the output unit 109 outputs the output image generated by the generating unit 108 to the display unit 402 of the information terminal 400 (step S308).

<Example Operation of System>

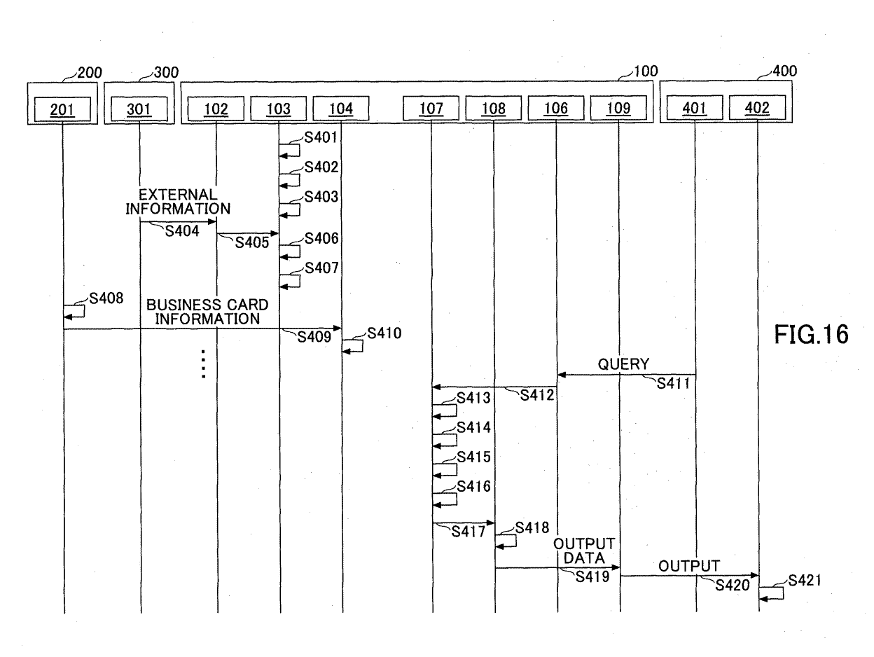

FIG. 16 is a sequence diagram for illustrating an example of an operation of the system 1 of the present embodiment. In the following, an example operation in a case where the company information of a newly managed company “Japan Corporation” will be described.

First, the creating unit 103 of the information processing apparatus 100 reads the organizational information 151 shown in FIG. 4, which has been defined in advance (step S401). Then, the creating unit 103 reads the position information 152 shown in FIG. 5, which has been defined in advance (step S402). The creating unit 103 creates the company information 153 including an entry of the “President” which does not belong to any department, and entries of five positions of the “Executive”, the “Business Unit President”, the “Director”, the “Manager” and the “Staff” respectively belonging to five respective departments (step S403).

Here, the creating unit 103 assigns the “Employee Code” to the respective created entries, where values of the items of the “Name” and the “Department Name” remain null, while the value of the items of the “Department Code” (101-105) and the “Position Code” (200-205) are set as those shown in FIG. 4 and FIG. 5. Also, the creating unit 103 sets the date (Apr. 1, 2014) when the company information management table is created in the item of the “Updated Date”, while setting “Negative” in the item of “Business Card”.

The external information acquiring unit 102 of the information processing apparatus 100 acquires the external information including the company name, the name of department, the name of position and the name of employee from the sending unit 301 of the information providing apparatus 300 (step S404). Here, the external information includes information of five people as follows.

“Company Name”; “Department Name”; “Position Name”; “Name”

“Japan Corporation”; “President”; “Sato Ichiro”

“Japan Corporation”; “Corporate Planning”; “Executive”; “Nakamura Jiro”

“Japan Corporation”; “Corporate Planning”; “Business Unit President”; “Kobayashi Saburo”

“Japan Corporation”; “General Affairs”; “Business Unit President”; “Sakamoto Hachi”

“Japan Corporation”; “General Affairs”; “Director”; “Hayashi Kyuko”

The external information acquiring unit 102 provides the creating unit 103 with the acquired external information (step S405).

Then, the creating unit 103 stores the department name, the position name, and the employee name, included in the external information, in the company information management table (step S406). Additionally, as described above, the department name of a person included in the external information and the corresponding department code may be automatically associated with each other by a database for associating the department names with the department codes. For example, the department name “Corporate Planning” is associated with the department code “101”, while the department name “General Affairs” is associated with the department code “102”. Thus, for example, it can be found that “Nakamura Jiro” has a department code “101” since his department name is “Corporate Planning” and has a position code “201” since his position name is “Executive”. Therefore, the creating unit 103 stores information related to “Nakamura Jiro” in the entry identified by the department code “101” and the position code “201”. FIG. 6 shows the company information table for “Japan Corporation” created by the process up to the current point.

Then, the creating unit 103 creates an entry of a company corresponding to the entries created in step S403, thereby updating the output setting information 154 shown in FIG. 8 (step S407). Here, the creating unit 103 assigns the company code “AAA” to the company code of the “Japan Corporation”, sets the display sequence as “101,102,103,104,105” which is the default setting, and sets the subsidiary company code as “AAB, AAC”. Additionally, for example, the company code is designated by the system administrator of the information processing apparatus 100, or is assigned automatically. Also, for example, the subsidiary company code is designated by the system administrator of the information processing apparatus 100.

Then, a salesperson meets with an employee of the “Japan Corporation”, thereby receiving his/her business card. The reading unit 201 of the business card reading apparatus 200 reads the business card, accepting an operation on the screen shown in FIG. 10 input by the salesperson (step S408). The reading unit 201 sends the business card information including the “Company Name”, the “Department Name”, the “Position Name”, the “Name” and the “Selected Department Name” to the business card information receiving unit 104 of the information processing apparatus 100 (step S409). In the example shown in FIG. 10, the business card information including the following information is sent to the business card information receiving unit 104.

“Company Name”; “Japan Corporation”

“Department Name”; “Corporate Planning”

“Position Name”; “Executive”

“Name”; “Nakamura Jiro”

“Selected Department Name”; “Corporate Planning”

Next, the updating unit 105 updates the company information 153 stored in the storage unit 101 based on the received business card information (step S410). For example, in a case where the above described business card information is received, the department name “Corporate Planning” corresponds to the department code “101” and the position name “Executive” corresponds to the position code “201”. Therefore, in the company information management table of “Japan. Corporation” (FIG. 6), the updating unit 105 stores the name “Nakamura Jiro” and the department name “Corporate Planning” in the entry identified by the department code “101” and the position code “201”. Also, the updating unit 105 sets the date “4/3/2014” when the business card information is received in the item “Updated Date”, and sets “Positive” in the item “Business Card”.

Then, some salespersons meet with employees of “Japan Corporation”, thereby further receiving their business cards. As a consequence, the company information management table of “Japan Corporation” becomes the one shown in FIG. 7.

The query accepting unit 106 of the information processing apparatus 100 accepts the query, which includes the user name of the salesperson “Yamazaki Kei” and company name “Japan Corporation” of the company whose information is to be displayed, sent from the query sending unit 401 of the information terminal 400 (step S411). The query accepting unit 106 informs the reading unit 107 of the acceptance of the query to provide the user name and the company name of the company whose information is to be displayed (step S412).

Then, the reading unit 107 retrieves the company information 153 corresponding to the informed company name “Japan Corporation” from the storage unit 101 (step S413). The reading unit 107 reads, with reference to the output setting information 154, the display sequence “101,102,103,104,105” and the subsidiary company code “AAB, AAC”, which corresponds to the informed company name “Japan Corporation” (step S414). The reading unit 107 further reads, with reference to the output setting information 154 shown in FIG. 8, the company code, the company name and the display sequence which correspond to the subsidiary company code “AAB, AAC” (step S415). Here, information of “Japan Logistics Corporation” and “Japan Information Corporation” is read.

Then, the reading unit 107 reads, with reference to the user setting information stored in the storage unit 101, the display sequence “101,103,105,104,102” corresponding to the user name “Yamazaki Kei” which is informed by the query accepting unit 106 (step S416). The reading unit 107 informs the generating unit 108 of the information read in step S413-S416 (step S417).

The generating unit 108 generates the output image of the company information to be output based on the information informed by the reading unit 107 (step S418). FIG. 11 shows an example of the output image generated by the generating unit 108. The generating unit 108 outputs the respective information in a tree state. The generating unit 108 disposes the company name “Japan Corporation” at the top of the tree and disposes every department included in the company information 153 under the company name “Japan Corporation”. Also, the generating unit 108 may dispose a special item “Executives”.

The generating unit 108 disposes the “Department Name” and the “Name” of the employees under the respective departments, where the employees have five types of positions. Here, the generating unit 108 outputs the information of the employees so that the information of the employees where “Positive” is set in the item “Business Card” is distinguished from that where “Negative” is set in the item “Business Card”. In the example of FIG. 11, the generating unit 108 outputs the “Department Name” and the “Name” of the employees, whose business cards have been received, in a clear color. Also, the generating unit 108 may list information of the employees whose position codes are “201” (that is, the “Executive”) under the item of “Executives”.

Further, the generating unit 108 may list the names of the subsidiary companies under the company name “Japan Corporation” shown at the top of the tree. In FIG. 11, the names of the subsidiary companies “Japan Logistics Corporation” and the “Japan Information Corporation” are shown under the company name “Japan Corporation”. Here, the names of the subsidiary companies may be hyper-linked, and for example, the company information of the subsidiary company may be displayed when the salesperson clicks the link.

The generating unit 108 provides the output unit 109 with the generated output data (step S419). Then, the output unit 109 outputs the output data to the display unit 402 in the information terminal 400 of the salesperson (step S420). The display unit 402 of the information terminal 400 displays the image of the output data on the display (step S421).

Additionally, the aforesaid creating unit 103 of the information processing apparatus 100 may back up the constituted company information 153 every certain period (for example, every six months) and newly constitute initial state company information 153. The process performed when the initial state company information 153 is newly constituted is similar to the process described with reference to the flowchart shown in FIG. 13. Thus, outputting the company information based on old information constituted before a certain date can be prevented.

<5. Effect>

As described above, the information processing apparatus 100 of the present embodiment creates a template of a customer's organization based on the information of departments and positions which have been defined in advance. Then, the business card information received from the customer is sequentially stored, and the information can be output in a form where the sales person can distinguish the department•position whose business card has been received from a department•position whose business card has not been received. Such information enables the salesperson to effectively plan which person in a department•position should be contacted during the next sales activity.

Additionally, a number of scanned business cards managing unit may be included in the storage unit 101, and the output unit 109 generates charge information based on a predetermined unit price and the number of scanned business cards to output it.

Herein above, although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth. The present application is based on Japanese Priority Application No. 2014-113163 filed on May 30, 2014, the entire contents of which are hereby incorporated herein by reference.

### DESCRIPTION OF THE REFERENCE NUMERALS

1 system
2 network
100 information processing apparatus
101 storage unit
102 external information acquiring unit
103 creating unit
104 business card information receiving unit
105 updating unit
106 query accepting unit
107 reading unit
108 generating unit
109 output unit
151 organizational information
152 position information
153 company information
154 output setting information
155 user setting information
200 business card reading apparatus
300 information providing apparatus
400 information terminal

1. An information processing apparatus of an information processing system in which a business card reading apparatus for reading business card information, the information processing apparatus for processing the business card information, and a terminal device capable of communicating with the information processing apparatus are connected with each other through a network, the information processing apparatus comprising:
a storage unit configured to store organizational information of respective organizations each including section information for indicating a section included in an organization and member information related to a member of the section;
an updating unit configured to update the organizational information, based on the section information and the member information of the section which are extracted from the business card information, so that the member information of the member whose business card information has been received can be distinguished from the member information of the member whose information of the business card has not been received, in the organizational information;
a generating unit configured to generate output information for outputting the organizational information where the member information of the member whose business card information has been received can be distinguished from the member information of the member whose business card information has not been received; and
an output unit configured to output the output information generated by the generating unit to the terminal device.

2. The information processing apparatus as claimed in claim 1, wherein the storage unit further stores a first display sequence information indicating a display sequence of the section information, and the generating unit generates the output information where the section information is output in accordance with the display sequence of the first display sequence information.

3. The information processing apparatus as claimed in claim 2, wherein the storage unit further stores a second display sequence information for indicating a display sequence of the section information for respective users, the generating unit generates the output information where the section information is output in accordance with the display sequence of the second display sequence information, for the respective users.

4. The information processing apparatus as claimed in claim 3, further comprising an accepting unit configured to accept a usage request including user information related to the user from the terminal device, wherein the generating unit generates the output information based on the second display sequence information in a case where the second display sequence information associated with the user information is stored in the storage unit, while generating the output information based on the first display sequence information in a case where the second display sequence information associated with the user information is not stored in the storage unit.

5. The information processing apparatus as claimed in claim 1, wherein the generating unit generates display information in the output information for displaying the member information in the organizational information in a different manner by using any one or combination of color of characters, a graduation of the color, or a size of the characters and icons, according to the receipt state of the information of the business card of the member.

6. The information processing apparatus as claimed in claim 1, wherein the section of the section information includes the section included in the respective organization, and the organization of the organizational information includes a company and an affiliate company.

7. The information processing apparatus as claimed in claim 1, wherein the output unit further outputs charge information based on usage of the information processing apparatus or usage of the business card reading apparatus.

8. The information processing apparatus as claimed in claim 1, wherein the section includes at least any one of a corporate management section, a planning section, a procurement section and a sales section.

9. An information processing method performed by an information processing apparatus of an information processing system in which a business card reading apparatus for reading business card information, the information processing apparatus for processing the business card information, and a terminal device capable of communicating with the information processing apparatus are connected with each other through a network, the information processing method comprising the steps of:
storing organizational information of respective organizations including section information for indicating a section included in an organization and member information related to a member of the section;
updating the organizational information, based on the section information and the member information of the section which are extracted from the business card information, so that the member information of the member whose business card information has been received can be distinguished from the member information of the member whose business card information has not been received, in the organizational information;
generating output information for outputting the organizational information where the member information of the member whose business card information has been received can be distinguished from the member information of the member whose business card information has not been received; and
outputting the output the generated information to the terminal device.

10. An information processing system in which a business card reading apparatus for reading business card information, an information processing apparatus for processing the business card information, and a terminal device capable of communicating with the information processing apparatus are connected with each other through a network, wherein the business card reading apparatus comprises:
a sending unit configured to send the business card information to the information processing apparatus;
the information processing apparatus comprises:
a storage unit configured to store organizational information of respective organizations including section information for indicating a section included in an organization and member information related to a member of the section;
an updating unit configured to update the organizational information, based on the section information and the member information of the section which are extracted from the business card information, so that the member information of the member whose business card information has been received can be distinguished from the member information of the member whose business card information has not been received, in the organizational information;
a generating unit configured to generate output information for outputting the organizational information where the member information of the member whose business card information has been received can be distinguished from the member information of the member whose business card information has not been received; and
an output unit configured to output the output information generated by the generating unit to the terminal device;
the terminal device comprises:
a receiving unit configured to receive the output information output from the output unit of the information processing apparatus; and
a display unit configured to display an image based on the received output information.
